(19) United States
(12) Patent Application Publication
(10) Pub. No.: US 2005/0089466 A1
(43) Pub. Date: Apr. 28, 2005

(54) Methods and apparatus for producing precipitated calcium carbonate

(76) Inventors: Mark G. DeGenova, Ste. Genevieve, MO (US); Randy J. Griffard, St. Mary, MO (US); G. Kevin Bequette, Ste. Genevieve, MO (US)

Correspondence Address: PATRICK W. RASCHE;ARMSTRONG TEASDALE LLP, ONE METROPOLITAN SQUARE, SUITE 2600, ST. LOUIS, MO, 63102-2740, US

(21) Appl. No.: 10/968,538

(22) Filed: Oct. 19, 2004

Related U.S. Application Data
(60) Provisional application No. 60/514,664, filed on Oct. 27, 2003.

(51) Int. Cl. C01F 11/18

(52) U.S. Cl. 423/430

(57) ABSTRACT

A method for producing precipitated calcium carbonate includes, in one embodiment, forming a hydrate or an oxide composed of lime particles, greater than 95% of the lime particles being as fine as or finer than about 45 microns, and carbonating the hydrate or oxide to form precipitated calcium carbonate having a brightness greater than or equal to 94.

### CROSS REFERENCE TO RELATED APPLICATIONS

This application claims the benefit of U.S. Provisional Application No. 60/514,644 filed Oct. 27, 2003.

### BACKGROUND OF THE INVENTION

This invention relates generally to the manufacture of precipitated calcium carbonate, and more particularly, the use of highly refined lime to form precipitated calcium carbonate.

Known methods of manufacturing precipitated calcium carbonate (PCC) include the step of forming slaked lime (Ca(OH)₂) from lime, for example, quicklime (CaO) by a slaking process where water and the lime are mixed under agitation and temperature to produce slaked lime. Impurities in the quicklime, for example, clay, silicate particles, and fuel related impurities, are also present in the slaked lime and need to be removed, usually by a screening process, prior to carbonating the slaked lime slurry. Because the screening process does not completely eliminate all the impurities, small particles of clay and silicates, follow the slaked lime into the PCC reactor. The finished PCC slurry is then screened again to try to remove these impurities. This screening process can also remove a portion of the PCC.

The quality of the PCC is dependent on the quality of the raw materials used to manufacture the PCC. Particularly, the amount of impurities in the quicklime, the amount of impurities remaining in the slaked lime, and the quality of the slaked lime. There are a number of variables in the slaking process that can affect the quality of the slaked lime, for example, the slaking temperature, the lime to water ratio, the amount of agitation during slaking, the viscosity of the slurry, the slaking time, the water temperature, the amount of soluble salts in the water, and the amount of air slaking. Because of these numerous variables that effect the slaked lime, the slaking process is a complex portion of the PCC manufacturing process.

### BRIEF DESCRIPTION OF THE INVENTION

In one aspect, a method for producing precipitated calcium carbonate is provided. The method includes forming at least one of a lime hydrate and a lime oxide composed of lime particles, greater than 95% of the lime particles being as fine as or finer than about 45 microns, and carbonating the at least one lime hydrate and lime oxide to form precipitated calcium carbonate having a TAPPI brightness greater than or equal to 94 when measured in accordance with TAPPI method T646 om-94.

In another aspect, a precipitated calcium carbonate having a TAPPI brightness greater than or equal to 94, measured in accordance with TAPPI method T646 om-94, is provided. The precipitated calcium carbonate is made by a process including the steps of forming at least one of a lime hydrate and a lime oxide composed of lime particles, greater than 95% of the lime particles having a dimension no greater than or equal to 45 microns, and carbonating the at least one lime hydrate and lime oxide.

In another aspect, a system for producing precipitated calcium carbonate is provided. The system includes a slurry makedown subsystem for forming a slurry from lime particles, greater than 95% of the lime particles having a dimension no greater than or equal to 45 microns, and at least one carbonator in flow communication with the slurry makedown subsystem for carbonating the slurry.

In another aspect, a method for producing precipitated calcium carbonate, is provided. The method includes forming an aqueous slurry of lime particles comprised of at least one of a lime hydrate and a lime oxide, greater than about 95% of the lime particles being about 45 microns or less, and carbonating the lime particles to form precipitated calcium carbonate having a TAPPI brightness greater than or equal to 94, measured by TAPPI method T646 om-94.

### BRIEF DESCRIPTION OF THE DRAWINGS

FIGS. 1A and 1B illustrate a known system for manufacturing precipitated calcium carbonate.

FIGS. 2A and 2B illustrate a system for manufacturing precipitated calcium carbonate in accordance with an embodiment of the present invention.

FIGS. 3A and 3B illustrate a system for manufacturing precipitated calcium carbonate in accordance with another embodiment of the present invention.

FIG. 4 illustrates a system for manufacturing precipitated calcium carbonate in accordance with another embodiment of the present invention.

### DETAILED DESCRIPTION OF THE INVENTION

Systems and methods for manufacturing precipitated calcium carbonate (PCC) using highly refined lime particles is described below in detail. The highly refined lime particles are mixed with water to form a slurry which is directed to a carbonator along with carbon dioxide. A reaction between the slurry of highly refined lime particles and the carbon dioxide forms a calcium carbonate precipitate. The slurry is delivered to the carbonator without using a slaker or screening. Optionally, the slurry is cooled before entering the carbonator. The systems and methods for manufacturing PCC described below eliminate the slaking system, the post-slaking screen and grit removal system, the lime slake cooling system and the PCC screening and grit removal system of known PCC manufacturing systems.

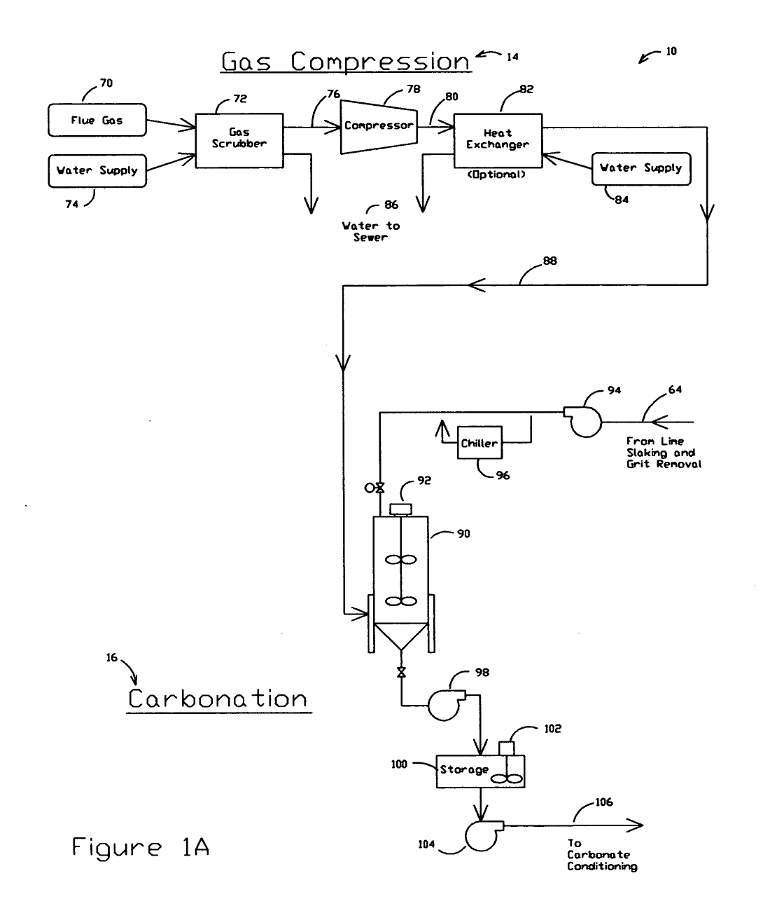

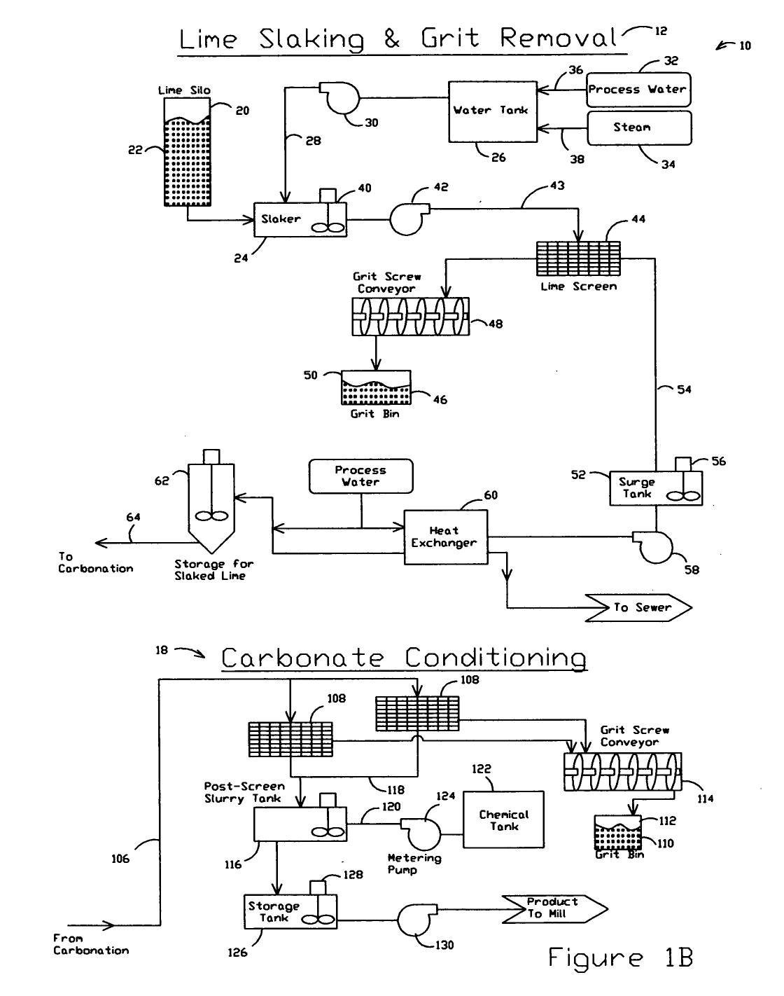

Referring to the drawings, FIGS. 1A and 1B illustrate a known system 10 for manufacturing PCC. System 10 includes a lime slaking and grit removal subsystem 12, a gas compression subsystem 14, a carbonation subsystem 16, and a carbonate conditioning subsystem 18.

Lime slaking and grit removal subsystem 12 includes a lime storage silo 20 for storing quicklime (CaO) 22. Storage silo 20 is coupled to a slaker 24 such that quick lime 22 can be feed into slaker 24 for processing. A water storage tank 26 is connected to slaker 24 by water feed line 28 and pump 30. Water tank 26 is connected to a process water supply 32 and a steam supply 34 by supply lines 36 and 38 respectively. Water and steam are mixed in water storage tank to provide the desired water temperature for slaking quicklime 22 in slaker 24. Slaker 24 includes a mixing agitator 40 for agitating the quicklime and water mixture during the slaking process. A pump 42 pumps slaked lime through a line 43 to screen 44 to remove oversize particles, or grit 46, from the slaked lime. Grit 46 is captured by screen 44 and sent via screw conveyor 48 to grit bin 50. The screened slaked lime is directed to a surge tank 52 through a line 54. Surge tank 52 includes a mixer 56 to maintain the slaked lime under agitation. A pump 58 pumps the slaked lime through a heat exchanger 60 and to a storage tank 62. Process water 32 is used as a cooling medium to reduce the temperature of the slaked lime in heat exchanger 60. A supply line 64 connects slaked lime storage tank 62 to carbonation subsystem 16.

Gas compression subsystem 14 includes a flue gas supply 70 as a source of carbon dioxide. Flue gas supply 70 is connected to a gas scrubber 72 along with a cooling water supply 74. Gas scrubber 72 scrubs and cools the flue gas. The quenched gases flow via line 76 to compressor 78 which increases the pressure of the gas stream, thus increasing the partial pressure of carbon dioxide supplied to carbonation system 16. The compressed gas stream 80 is optionally sent to a heat exchanger 82 for cooling of the gas stream by a water stream 84 which is returned to sewer 86. The optional cooling of compressed gas stream is dependent on the type of crystal desired The cooled, compressed gas containing carbon dioxide under pressure is sent to carbonation subsystem 16 through gas line 88.

Carbonation subsystem 16 includes a batch carbonator 90. Carbonator 90 includes a mixer 92 to maintain the slaked lime and carbon dioxide mixture under agitation during the carbonation process where the PCC is formed. Compressed gas stream line 88 is connected to carbonator 90 and supply line 64 connects slaked lime storage tank 62 to carbonator 90. A pump 94 in supply line 64 facilitates pumping the slaked lime to carbonator 90. A chiller 96 is used to control the temperature of the slaked lime slurry in carbonator 90. The correct milk of lime temperature is a variable which can affect the type and size of the resultant PCC crystals. Start temperatures of 30° F. to 60° F. favor rhombohedral, temperatures of 60° F. to 95° F. favor schalenohedral, and temperatures greater than 95° F. favor aragonite.

The carbonation reaction between carbon dioxide and slaked lime is carried out under pressure in carbonator 90. The reaction forms a PCC, and can be characterized by the equation:
Ca(OH)₂+CO₂→CaCO₃+H₂O

The pressure in carbonator 90 can range from above atmospheric pressure to as much as about 100 psig. Typically, the pressure in carbonator 90 is maintained at atmospheric pressure. In a pressure carbonator, pressure is typically maintained at about 30 psig. Inert gas and any residual carbon dioxide not utilized in carbonator 90 is vented to the atmosphere.

The PCC formed in carbonator 90 is pumped by pump 98 to a storage tank 100 that includes an agitator 102. A discharge pump 104 moves the PCC through line 106 to carbonate conditioning subsystem 18.

Carbonate conditioning system 18 includes screens 108 that remove any oversized material from the PCC. Discharge line 106 connects PCC storage tank 100 with screens 108. The oversized material or grit 110 removed by screens 108 is directed to a grit bin 112 by a grit screw conveyor 114. The screened PCC is directed into tank 116 by a line 118. An input line 112 supplies additional selected chemicals, for example acid, from a chemical tank 122 to tank 116 via a metering pump 124, to minimize any pH rise and associated loss of product. The screened and conditioned PCC is stored in tank 126, and mixed with agitator 128, before being sent via a pump 130 to subsequent filtration, filtration/drying or to a mill, for example, a paper mill.

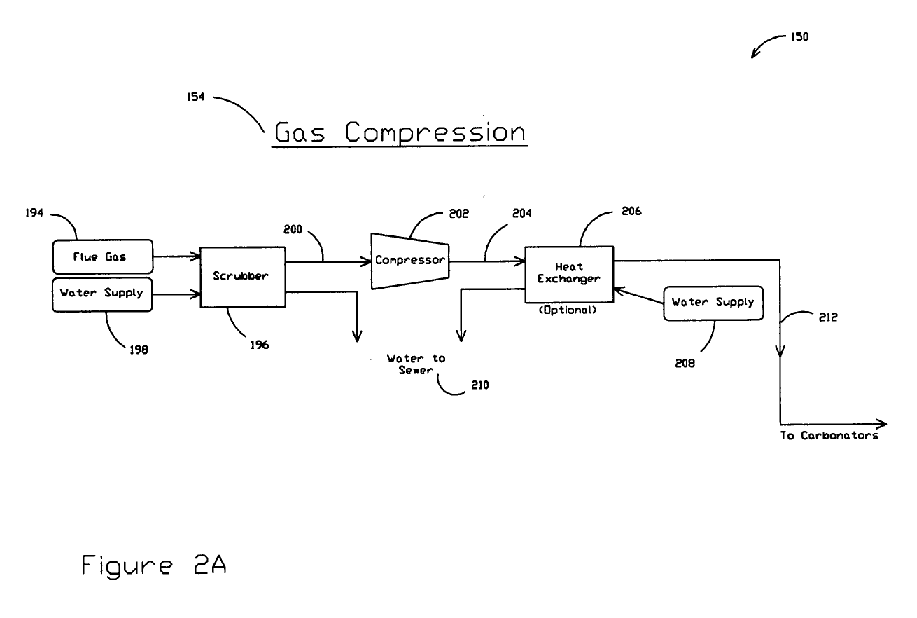

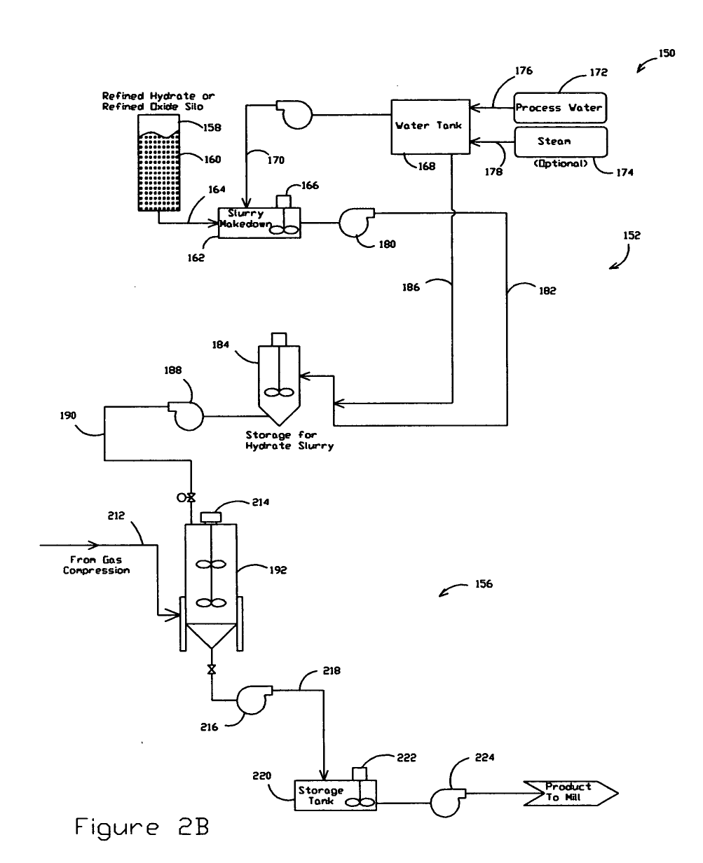

FIGS. 2A and 2B illustrate a system 150 for manufacturing precipitated calcium carbonate in accordance with an exemplary embodiment of the present invention. System 150 includes a lime slurry makedown subsystem 152, a gas compression subsystem 154, and a carbonation subsystem 156.

Lime slurry makedown subsystem 152 includes a storage silo 158 for storing highly refined hydrated lime 160. Highly refined hydrated lime is defined as hydrated lime that has been micronized so that greater than 95% of the highly refined lime particles are 45 microns or finer. Micronized hydrated lime is commercially available under the trade name MICRO CAL-H from Mississippi Lime Company, St. Genevieve, Mo. In an alternate embodiment, a highly refined lime oxide can be used. Micronized lime oxide is commercially available under the trade name MICRO CAL-O from Mississippi Lime Company. In another embodiment, a blend of highly refined hydrate and highly refined oxide can be used. Variations in the blend ratio can be determined that give the desired start temperature. Storage silo 158 is connected to a slurry makedown tank 162 by a feed line 164. Slurry makedown tank 162 includes a mixing agitator 166 for mixing highly refined lime 160 with water from a water storage tank 168. A feed line 170 connects water tank 168 to slurry makedown tank 162. Water tank 168 is connected to a process water supply 172 and a steam supply 174 by supply lines 176 and 178 respectively. Water and steam are mixed in water storage tank 168 to provide the desired water temperature for forming the lime slurry. A pump 180 pumps the lime slurry through a line 182 which is connected to a lime slurry storage tank 184. Water from storage tank 168 can be added to the lime slurry through a line 186 to adjust the viscosity and/or concentration of the lime slurry. A pump 188 pumps the lime slurry through a discharge line 190 which is connected to a carbonator 192.

Gas compression subsystem 154 is similar to gas compression subsystem 14 described above and includes a flue gas supply 194 as a source of carbon dioxide. Flue gas supply 194 is connected to a gas scrubber 196 along with a cooling water supply 198. Gas scrubber 196 scrubs and cools the flue gas. The quenched gases flow via a line 200 to compressor 202 which increases the pressure of the gas stream, thus increasing the partial pressure of carbon dioxide supplied to carbonator 192. The compressed gas stream 204 is sent to an optional heat exchanger 206 for cooling of the gas stream by a water stream 208 which is returned to a sewer 210. The optional cooling of compressed gas stream is dependent on the type of crystal desired The cooled, compressed gas containing carbon dioxide under pressure is sent to carbonator 192 through gas line 212.

Carbonation subsystem 156 includes batch carbonator 192. Carbonator 192 includes a mixer 214 to maintain the lime slurry and carbon dioxide mixture under agitation during the carbonization process while the PCC is formed. Gas line 212 is connected to carbonator 192 and lime slurry discharge line 190 is connected to carbonator 192.

The carbonation reaction between carbon dioxide and the slurry of highly refined lime is carried out in carbonator 192. The reaction forms a PCC that is improved over PCC formed in known systems. Specifically, the PCC formed in system 150 has a TAPPI brightness equal to or greater than 94 as measured in accordance with TAPPI brightness method T646 om-94 “Brightness of clay and other mineral pigments (45°/0°)”.

The PCC formed in carbonator 192 is pumped by pump 216 through a discharge line 218 connected to a storage tank 220. The PCC is mixed with agitator 222 before being pumped by a pump 224 to subsequent filtration, filtration/drying or to a mill, for example, a paper mill.

In operation, highly refined lime in the form of calcium hydroxide, calcium oxide, or a blend of the two is moved from storage silo 158 through feed line 164 into slurry makedown tank 162 and mixed with water from water storage tank 168. The resultant lime slurry is then pumped to storage tank 184 through line 182 where the viscosity and/or concentration of the slurry is adjusted with additions of water from storage tank 168. The slurry is then pumped to carbonator 192 through discharge line 190. Carbon dioxide from gas compression subsystem 154 is added to carbonator 192 through gas line 212. The lime slurry and carbon dioxide mixture is agitated with mixer 214 during the carbonation process. The resultant PCC is pumped from carbonator 192 to storage tank 222 where the PCC is mixed with agitator 222 before being pumped to subsequent filtration, filtration/drying or to a mill, for example, a paper mill.

The above described system 150 utilizes a highly refined lime hydrate and/or lime oxide to form PCC. The highly refined lime hydrate includes only minute amounts of residue when screened through a 325 mesh screen, less than 0.1% by weight, and as a result the slurry formed with the highly refined lime does not need to be screened. Because of the low amount of contaminates, the resultant PCC formed from the slurry has increased TAPPI brightness. Further, the use of highly refined lime hydrate and/or oxide eliminates the need for a lime slaker and a screening process, thereby lowering costs and waste production, and reducing system complexity.

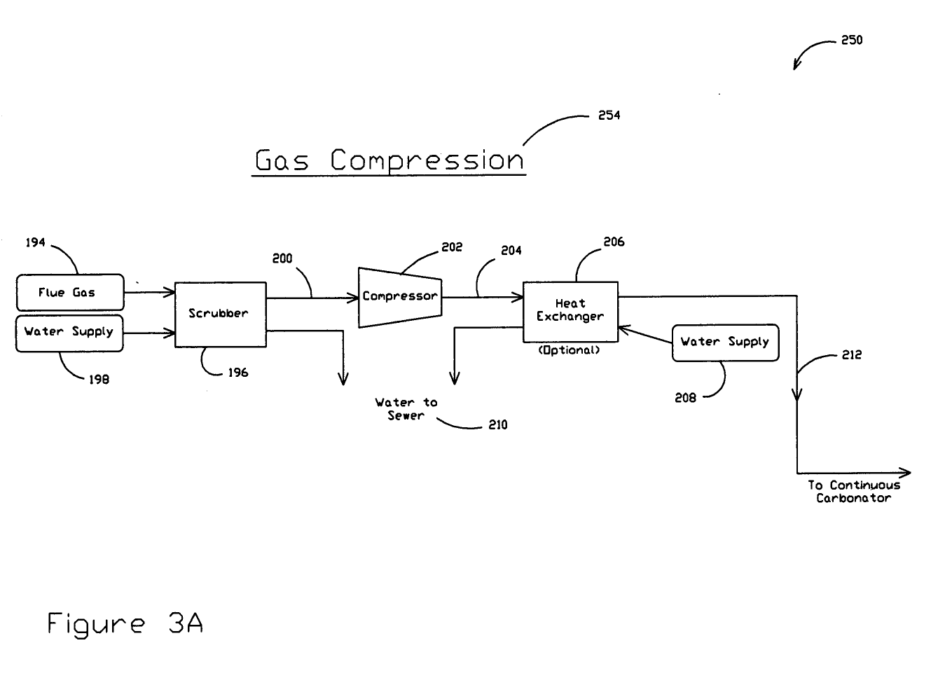

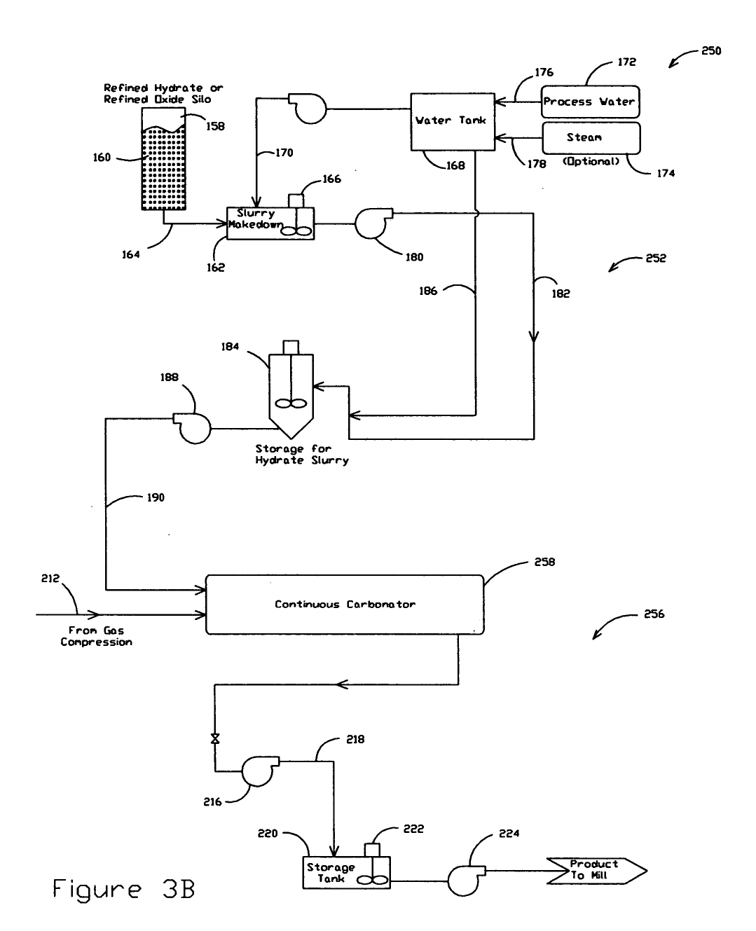

FIGS. 3A and 3B illustrate a system 250 for manufacturing precipitated calcium carbonate in accordance with another exemplary embodiment of the present invention. System 250 is similar to system 150 described above and includes a lime slurry makedown subsystem 252, a gas compression subsystem 254, and a carbonation subsystem 256.

Lime slurry makedown subsystem 252 and gas compression subsystem 254 are identical to lime slurry makedown subsystem 152 and gas compression subsystem 154 described above.

Carbonation subsystem 256 includes a continuous carbonator 258 rather than a batch carbonator 192 as described above. Continuous carbonator 258 is connected to lime slurry makedown subsystem 252 by discharge line 190 and to gas compression subsystem 254 by gas line 212. A continuous flow of lime slurry and carbon dioxide enter continuous carbonator 258 through discharge line 190 and gas line 212 respectively. As the lime slurry and carbon dioxide flow through carbonator 258, the carbonation reaction described above takes place forming PCC which flows out of carbonator 258 through discharge line 218 to storage tank 220. The PCC is mixed with agitator 222 before being pumped to a mill, for example, a paper mill, by pump 224

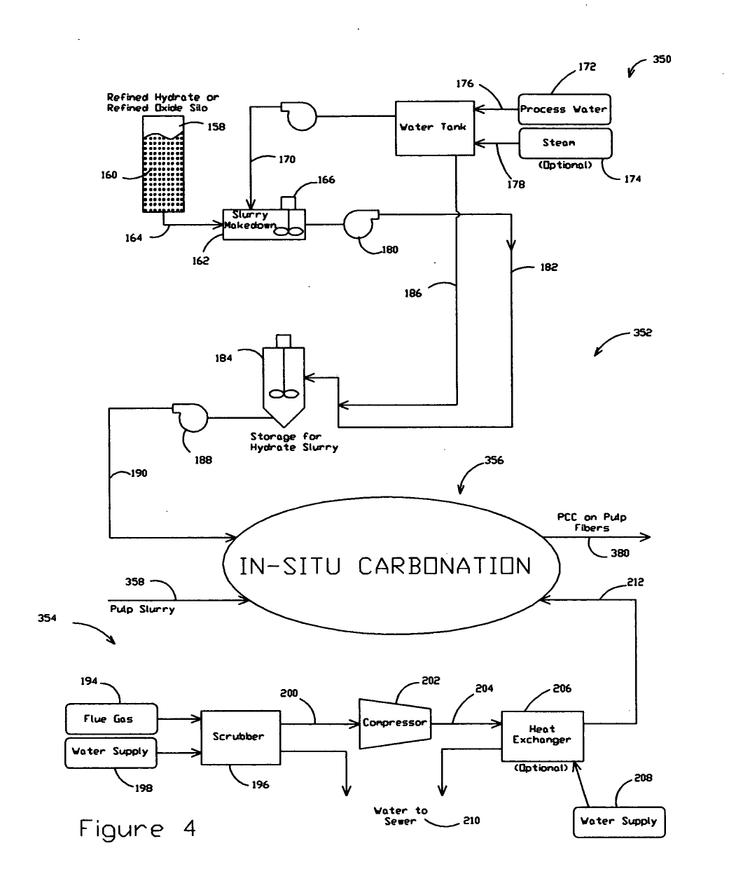

FIG. 4 illustrates a system 350 for manufacturing precipitated calcium carbonate in accordance with another exemplary embodiment of the present invention. System 350 is similar to system 150 described above and includes a lime slurry makedown subsystem 352, a gas compression subsystem 354, and an in-situ carbonation subsystem 356.

Lime slurry makedown subsystem 352 and gas compression subsystem 354 are identical to lime slurry makedown subsystem 152 and gas compression subsystem 154 described above.

In-situ carbonation subsystem 356 is connected to lime slurry makedown subsystem 352 by discharge line 190 and to gas compression subsystem 254 by gas line 212. In-situ carbonation subsystem 356 is located in the mill or plant process where the PCC is to be used. For example, in a paper mill, lime slurry discharge line 190 and carbon dioxide gas line 212 are connected directly to the paper manufacturing processing equipment and the carbonation process and the formation of PCC takes place in the paper manufacturing equipment as the paper is being manufactured. Specifically, in paper manufacturing processing equipment, a pulp slurry line 358 feeds pulp slurry into subsystem 356 and a discharge line 380 conveys PCC on pulp fibers from subsystem 356.

While the invention has been described in terms of various specific embodiments, those skilled in the art will recognize that the invention can be practiced with modification within the spirit and scope of the claims.

1. A method for producing precipitated calcium carbonate, said method comprising:
forming at least one of a lime hydrate and a lime oxide composed of lime particles, greater than about 95% of the lime particles being as fine as or finer than about 45 microns; and
carbonating the at least of one lime hydrate and lime oxide to form precipitated calcium carbonate having a TAPPI brightness greater than or equal to 94, measured by TAPPI method T646 om-94.

2. A method in accordance with claim 1 further comprising forming an aqueous slurry of lime particles by mixing water and the lime particles.

3. A method in accordance with claim 2 wherein carbonating the at least one of lime hydrate and lime oxide comprises mixing the aqueous slurry with carbon dioxide in a batch carbonator vessel.

4. A method in accordance with claim 2 wherein carbonating the at least one of lime hydrate and lime oxide comprises mixing the aqueous slurry with carbon dioxide in a continuous carbonator vessel.

5. A method in accordance with claim 2 wherein carbonating the at least one of lime hydrate and lime oxide comprises mixing the aqueous slurry with carbon dioxide in-situ in a plant manufacturing process that uses precipitated calcium carbonate as a component of the plant manufacturing process.

6. A method in accordance with claim 2 wherein carbonating the at least one of lime hydrate and lime oxide comprises carbonating the at least one lime hydrate and lime oxide at a pressure of about one atmosphere to about 100 psi.

7. A precipitated calcium carbonate having a TAPPI brightness greater than or equal to 94, measured by TAPPI method T646 om-94, said precipitated calcium carbonate made by a process comprising the steps of:
forming at least one of a lime hydrate and a lime oxide composed of lime particles, greater than about 95% of the lime particles being as fine as or finer than about 45 microns; and
carbonating the at least one lime hydrate and lime oxide to form precipitated calcium carbonate having a TAPPI brightness greater than or equal to 94, measured by TAPPI method T646 om-94.

8. A precipitated calcium carbonate in accordance with claim 7 wherein the process further comprises forming an aqueous slurry of lime particles by mixing water and the lime particles.

9. A precipitated calcium carbonate in accordance with claim 8 wherein said step carbonating the at least one of lime hydrate and lime oxide comprises mixing the aqueous slurry with carbon dioxide in a batch carbonator vessel.

10. A precipitated calcium carbonate in accordance with claim 8 wherein said step carbonating the at least one of lime hydrate and lime oxide comprises mixing the aqueous slurry with carbon dioxide in a continuous carbonator vessel.

11. A precipitated calcium carbonate in accordance with claim 8 wherein said step carbonating the at least one of lime hydrate and lime oxide comprises mixing the aqueous slurry with carbon dioxide in-situ in a plant manufacturing process that uses precipitated calcium carbonate as a component of the plant manufacturing process.

12. A precipitated calcium carbonate in accordance with claim 8 wherein said step carbonating the at least one of lime hydrate and lime oxide comprises carbonating the at least one of lime hydrate and lime oxide at a pressure of about one atmosphere to about 100 psi.

13. A system for producing precipitated calcium carbonate, said system comprising:
a slurry makedown subsystem for forming a slurry of lime particles, greater than 95% of the lime particles having a dimension no greater than or equal to about 45 microns; and
at least one carbonator in flow communication with said slurry makedown subsystem for carbonizing the slurry.

14. A system for producing precipitated calcium carbonate in accordance with claim 13 further comprising a compressed carbon dioxide subsystem coupled to said at least one carbonator.

15. A system for producing precipitated calcium carbonate in accordance with claim 13 wherein said slurry makedown subsystem comprises:
a storage tank comprising at least one of a lime hydrate and a lime oxide composed of lime particles, greater than about 95% of the lime particles being as fine as or finer than about 45 microns;
s slurry makedown tank connected to said storage tank by a feed line; and
a water feed line connected to said slurry makedown tank.

16. A system for producing precipitated calcium carbonate in accordance with claim 13 wherein said at least one carbonator comprises a batch carbonator.

17. A system for producing precipitated calcium carbonate in accordance with claim 13 wherein said at least one carbonator comprises a continuous carbonator.

18. A system for producing precipitated calcium carbonate in accordance with claim 13 wherein said at least one carbonator comprises an in-situ carbonator.

19. A method for producing precipitated calcium carbonate, said method comprising:
forming an aqueous slurry of lime particles comprised of at least one of a lime hydrate and a lime oxide, greater than about 95% of the lime particles being about 45 microns or less; and
carbonating the lime particles to form precipitated calcium carbonate having a TAPPI brightness greater than or equal to 94, measured by TAPPI method T646 om-94.

20. A method in accordance with claim 19 wherein carbonating the lime particles comprises mixing the aqueous slurry with carbon dioxide in a batch carbonator vessel.

21. A method in accordance with claim 19 wherein carbonating the lime particles comprises mixing the aqueous slurry with carbon dioxide in a continuous carbonator vessel.

22. A method in accordance with claim 19 wherein carbonating the lime particles comprises mixing the aqueous slurry with carbon dioxide in-situ in a plant manufacturing process that uses precipitated calcium carbonate as a component of the plant manufacturing process.

23. A method in accordance with claim 19 wherein carbonating the lime particles comprises carbonating the lime particles at a pressure of about one atmosphere to about 100 psi.
